(19) United States
(12) Patent Application Publication
(10) Pub. No.: US 2026/0035036 A1
(43) Pub. Date: Feb. 5, 2026

(54) VEHICLE LANE CHANGE

(71) Applicant: Ford Global Technologies, LLC, Dearborn, MI (US)

(72) Inventors: Jay Patel, Union City, CA (US); Pradeep Rajalingam, Woodhaven, MI (US); Rahul Reddy Nagavally, Dearborn, MI (US); Roman Atilla Koch, Aachen (DE); Carsten Schmeichel, Sankt Augusti (DE)

(73) Assignee: Ford Global Technologies, LLC, Dearborn, MI (US)

(21) Appl. No.: 18/792,140

(22) Filed: Aug. 1, 2024

(51) Int. Cl. B60W 30/09; B60W 40/04; G06V 20/56; G06V 20/58

(52) U.S. Cl. CPC B62D 15/0255; B60W 30/18163

(57) ABSTRACT

A system including a computer having a processor and a memory. The memory includes instructions executable by the processor to determine that a vehicle is in a passing lane of a highway and in response to a determination that a rearward vehicle in the passing lane is approaching or closely following the host vehicle, actuate a component of the host vehicle.

### BACKGROUND

Vehicles can operate in various modes in which one or more components such as a propulsion and/or a steering system of the vehicle are controlled by a vehicle computer. Various existing systems include adaptive cruise control, which can control velocity of a vehicle; lane-centering, in which vehicle steering is controlled to maintain a lateral position of a vehicle in the center of a lane of travel; and lane-changing, in which vehicle steering can be controlled to move a vehicle from one lane of travel to another.

### BRIEF DESCRIPTION OF THE DRAWINGS

FIG. 1 is a block diagram of an example system for a vehicle.

FIG. 2 is a diagram of an example traffic scenario illustrating a closely following vehicle.

FIG. 3 is a diagram of an example traffic scenario illustrating an approaching vehicle.

FIG. 4 is a diagram of an example traffic scenario illustrating an opening for a lane change.

FIG. 5 is a process flow diagram illustrating an example process for initiating a vehicle lane change.

### DETAILED DESCRIPTION

This disclosure provides techniques for controlling vehicle components, features, and/or systems in response to determining that a rearward vehicle is approaching, or closely following (i.e., following within a predetermined distance), a vehicle that is in the passing lane of a highway. In an example, the system determines that a rearward vehicle is closely following when a separation distance between the vehicle and the rearward vehicle is less than a distance that the rearward vehicle will travel in a specified amount of time. In an example, the system determines that a rearward vehicle is approaching when the rearward vehicle will reach the vehicle in less than a threshold amount of time. The specified amount of time and the threshold amount of time can be predetermined values based on user input and/or rules and regulations specific to the location and operation of the vehicle (e.g., Federal, state, country, city, etc.).

In response to a determination that a rearward vehicle is approaching or closely following a host vehicle that is in the passing lane of a highway, the computer 104 can actuate components and/or systems of the host vehicle. In an example, the computer 104 can initiate a lane change to move the host vehicle out of the passing lane including actuating an actuator of a vehicle steering system, for example.

Disclosed herein is a system including a computer having a processor and a memory. The memory includes instructions executable by the processor to determine that a host vehicle is in a passing lane of a highway, and in response to a determination that a rearward vehicle in the passing lane is approaching or closely following the host vehicle, actuate a component of the host vehicle.

The instructions to determine that the rearward vehicle is closely following the host vehicle can include instructions to determine that a separation distance between the host vehicle and the rearward vehicle is less than a distance that the rearward vehicle will travel in a specified amount of time.

The instructions to determine that the rearward vehicle is approaching the host vehicle can include instructions to determine that the rearward vehicle will reach the host vehicle in less than a threshold amount of time.

The instructions to determine that the rearward vehicle is approaching the host vehicle can include further instructions to determine that a separation distance between the host vehicle and the rearward vehicle is less than a distance that the rearward vehicle will travel in a specified amount of time.

The instructions to determine that the rearward vehicle is approaching the host vehicle can include instructions to determine that the rearward vehicle will reach the host vehicle in greater than a low threshold amount of time.

The instructions can include further instructions to determine that a gap exists between a forward adjacent vehicle and a rearward adjacent vehicle in a lane adjacent to the passing lane.

The component can be an actuator of a steering system of the host vehicle.

The instructions can include further instructions to actuate the actuator to move the host vehicle out of the passing lane.

The determination that the rearward vehicle is approaching or closely following the host vehicle can be based on distance information received from a host vehicle sensor.

The determination that the host vehicle is in the passing lane can be based on lane attributes identified by a host vehicle camera.

Disclosed herein is a method including, determining that a host vehicle is in a passing lane of a highway, and in response to a determination that a rearward vehicle in the passing lane is approaching or closely following the host vehicle, actuating a component of the host vehicle.

Determining that the rearward vehicle is closely following the host vehicle can include determining that a separation distance between the host vehicle and the rearward vehicle is less than a distance that the rearward vehicle will travel in a specified amount of time.

Determining that the rearward vehicle is approaching can include determining that the rearward vehicle will reach the host vehicle in less than a threshold amount of time.

Determining that the rearward vehicle is approaching can include determining that a separation distance between the host vehicle and the rearward vehicle is less than a distance that the rearward vehicle will travel in a specified amount of time.

Determining that the rearward vehicle is approaching can include determining that the rearward vehicle will reach the host vehicle in greater than a low threshold amount of time.

The method can include determining that a gap exists between a forward adjacent vehicle and a rearward adjacent vehicle in a lane adjacent to the passing lane.

The method can include actuating the actuator to move the host vehicle out of the passing lane.

The determination that the host vehicle is in the passing lane can be based on location information from a host vehicle GNSS sensor.

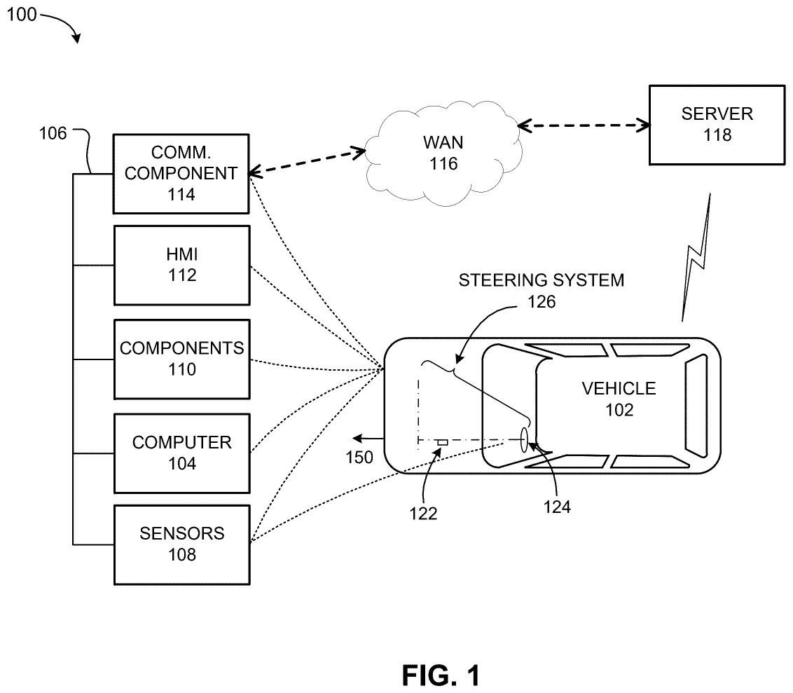

FIG. 1 is a block diagram of an example vehicle system 100. As shown in FIG. 1, system 100 includes a host vehicle 102, which in turn includes computer 104 that is communicatively coupled, e.g., via vehicle network 106, to various elements including sensors 108, subsystems or components 110, such as steering, propulsion, braking, human machine interface (HMI) 112, and communication component 114. Computer 104, and server 118 discussed below, include a processor and a memory. A memory of computer 104, such as those described herein, includes one or more forms of non-transitory media readable by computer 104, and can store instructions executable by computer 104 for performing various operations, such that the vehicle computer is configured to perform the various operations, including those disclosed herein.

For example, computer 104 can include a generic computer with a processor and memory as described above and/or may comprise an electronic control unit (ECU) or a controller for a specific function or set of functions, and/or a dedicated electronic circuit including an ASIC (application specific integrated circuit) that is manufactured for a particular operation, (e.g., an ASIC for processing data from sensors and/or communicating data from sensors 108). In another example, computer 104 may include an FPGA (Field-Programmable Gate Array), which is an integrated circuit manufactured to be configurable by a user. In example embodiments, a hardware description language such as VHDL (Very High Speed Integrated Circuit Hardware Description Language) may be used to describe digital and mixed-signal systems such as FPGA and ASIC. For example, an ASIC is manufactured based on VHDL programming provided pre-manufacturing, whereas logical components inside an FPGA may be configured based on VHDL programming, e.g., stored in a memory electrically connected or coupled to the FPGA circuit. In some examples, a combination of processor(s), ASIC(s), and/or FPGA circuits may be included in computer 104. Further, computer 104 may include a plurality of computers in the vehicle (e.g., a plurality of ECUs or the like) operating together to perform operations ascribed herein to the computer 104.

A memory of computer 104 can include any type, such as hard disk drives, solid state drives, or any other volatile or non-volatile media. The memory can store the collected data transmitted by sensors 108. The memory can be a separate device from computer 104, and computer 104 can retrieve information stored by the memory via a communication network in the vehicle such as vehicle network 106, e.g., over a controller area network (CAN) bus, a local interconnect network (LIN) bus, a wireless network, etc. Alternatively or additionally, the memory can be part of computer 104, for example, as a memory internal to computer 104.

Computer 104 can include or access instructions to operate one or more components 110 such as vehicle brakes, propulsion (e.g., one or more of an internal combustion engine, electric motor, hybrid engine, etc.), steering, climate control, interior and/or exterior lights, infotainment, navigation etc., as well as to determine whether and when computer 104, as opposed to a human operator, is to control such operations. Computer 104 can include or be communicatively coupled, e.g., via vehicle network 106, to more than one processor, which can be included in components 110 such as sensors 108, electronic control units (ECUs) or the like included in the vehicle for monitoring and/or controlling various vehicle components, e.g., a powertrain controller, a brake controller, a steering controller, etc.

As used herein, a steering system means a set of mechanical and/or electromechanical components used to steer vehicle 102. Accordingly, for example, steering system 126 can include steering wheel 124, as well as a steering column connected to steering wheel 124. Steering system 126 can also include an electronic power assistance steering (EPAS) motor or actuator 122 that operates to amplify and/or augment torque transmitted from steering wheel 124 to a pinion gear positioned on a steering rack of vehicle 102. Steering system 126 can further include bushings, seals, fluid couplings, steering rods, steering dampers, etc., which assist in controlling the heading of vehicle 102 as the vehicle moves along a path 150.

Computer 104 may be generally arranged for communications on vehicle network 106 that can include a communications bus in the vehicle, such as a controller area network CAN or the like, and/or other wired and/or wireless mechanisms. Vehicle network 106 corresponds to a communications network, which can facilitate exchange of messages between various onboard vehicle devices, e.g., sensors 108, components 110, computer 104. Computer 104 can be generally programmed to send and/or receive, via vehicle network 106, messages to and/or from other devices of vehicle 102, e.g., any or all of ECUs, sensors 108, actuators, components 110, communications component 114, HMI 112. For example, various component 110 subsystems (e.g., components 110) can be controlled by respective ECUs.

Further, in implementations in which computer 104 actually comprises a plurality of devices, vehicle network 106 may be used for communications between devices represented as computer 104 in this disclosure. For example, vehicle network 106 can provide a communications capability via a wired bus, such as a CAN bus, a LIN bus, or can utilize any type of wireless communications capability. Vehicle network 106 can include a network in which messages are conveyed using any other wired communication technologies and/or wireless communication technologies, e.g., Ethernet, Wi-Fi®, Bluetooth®, etc. Additional examples of protocols that may be used for communications over vehicle network 106 in some implementations include, without limitation, Media Oriented System Transport (MOST), Time-Triggered Protocol (TTP), and FlexRay. In some implementations, vehicle network 106 can represent a combination of multiple networks, possibly of different types, that support communications among devices onboard a vehicle. For example, vehicle network 106 can include a CAN bus, in which some in-vehicle sensors and/or components communicate via a CAN bus, and a wired or wireless local area network in which some device in vehicle communicate according to Ethernet, Wi-Fi®, and/or Bluetooth communication protocols.

Vehicle 102 typically includes a variety of sensors 108. Sensors 108 can include a suite of devices that can obtain one or more measurements of one or more physical phenomena. Some of sensors 108 can detect data that characterize the operational environment of the vehicle, such as vehicle speed (e.g., from vehicle wheel speed sensors), vehicle towing parameters, vehicle braking parameters, engine torque output, engine and transmission temperatures, battery temperatures, vehicle steering angles, etc. Some of sensors 108 can detect data that characterize the physical environment of vehicle 102, such as ambient air temperature, humidity, weather conditions (e.g., rain, snow, etc.), parameters related to the inclination or gradient of a road or other type of path on which the vehicle is proceeding, etc. In examples, sensors 108 can operate to detect the position and/or orientation of the vehicle utilizing, for example, signals from a Global Navigation Satellite System (GNSS) sensor, e.g., GLONASS, GPS, Galileo, Beidou; accelerometers, such as piezo-electric or microelectromechanical systems MEMS; gyroscopes such as rate, ring laser, or fiber-optic gyroscopes; inertial measurement units IMU; and magnetometers. In examples, sensors 108 can include sensors to detect aspects of the environment external to vehicle 102, such as radar sensors, scanning laser range finders, cameras, etc. Sensors 108 can also include light detection and ranging (LIDAR) sensors, which operate to detect distances to objects by emitting a laser pulse and measuring the time of flight for the pulse to travel to the object and back. Sensors 108 may include a controller and/or a microprocessor, which executes instructions to perform, for example, analog-to-digital conversion to convert sensed analog measurements and/or observations to input signals that can be provided to computer 104, e.g., via vehicle network 106.

Computer 104 can be configured for utilizing vehicle-to-vehicle (V2V) communications via communication component 114 and/or may interface with devices outside of the vehicle, e.g., through wide area network (WAN) 116 via V2V communications. Computer 104 can communicate outside of vehicle 102, such as via vehicle-to-infrastructure (V2I) communications, vehicle-to-everything (V2X) communications, or V2X including cellular communications C-V2X, and/or wireless communications cellular dedicated short-range communications DSRC, etc. Communications outside of vehicle 102 can be facilitated by direct radio frequency communications and/or via network server 118. Communications component 114 can include one or more mechanisms by which computer 104 communicates with vehicles outside of vehicle 102, including any desired combination of wireless, e.g., cellular, wireless, satellite, microwave, radio frequency communication mechanisms and any desired network topology or topologies when a plurality of communication mechanisms are used.

Vehicle 102 can include HMI 112, e.g., one or more of an infotainment display, a touchscreen display, a microphone, a speaker, a haptic device, etc. A user, such as the operator of vehicle 102, can provide input to devices such as computer 104 via HMI 112. HMI 112 can communicate with computer 104 via vehicle network 106, e.g., HMI 112 can send a message including the user input provided via a touchscreen, microphone, a camera that captures a gesture, etc., to computer 104, and/or can display output, e.g., via a display, speaker, etc. Further, operations of HMI 112 can be performed by a portable user device (not shown) such as a smart phone or the like in communication with computer 104, e.g., via Bluetooth or the like.

WAN 116 can include one or more mechanisms by which computer 104 may communicate with server 118. Server 118 can include an apparatus having one or more computing devices, e.g., having respective processors and memories and/or associated data stores, which may be accessible via WAN 116. In example embodiments, vehicle 102 could include a wireless transceiver (i.e., transmitter and/or receiver) to send and receive messages outside of vehicle 102. Accordingly, the network can include one or more of various wired or wireless communication mechanisms, including any desired combination of wired e.g., cable and fiber and/or wireless, e.g., cellular, wireless, satellite, microwave, and radio frequency communication mechanisms and any desired network topology or topologies when multiple communication mechanisms are utilized. Exemplary communication networks include wireless communication networks, e.g., using Bluetooth, Bluetooth Low Energy BLE, IEEE 802.11, V2V or V2X such as cellular V2X CV2X, DSRC, etc., local area networks and/or wide area networks 116, including the Internet.

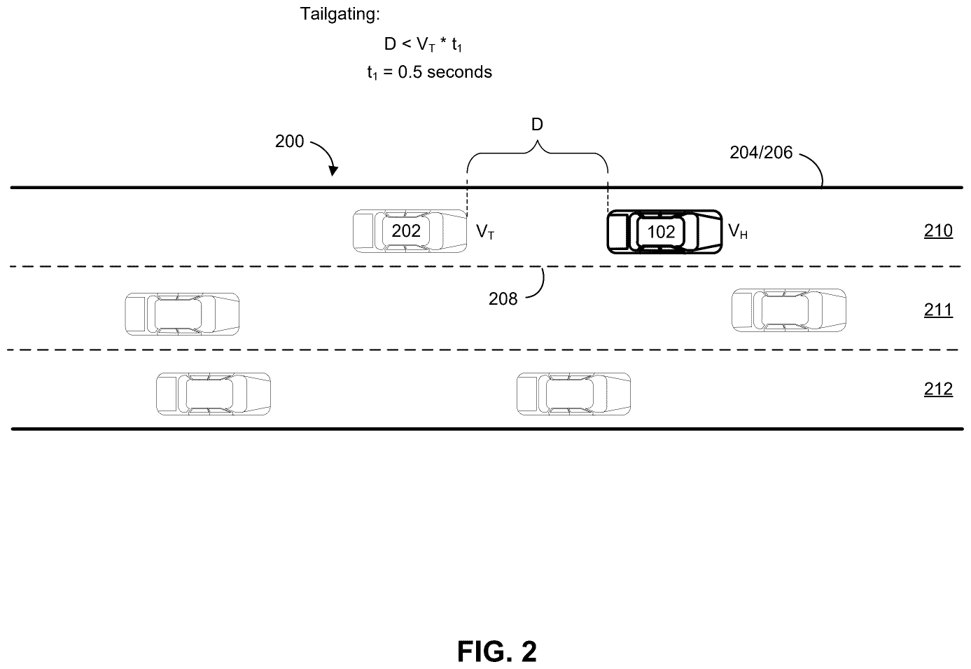

With reference to FIG. 2, the disclosed systems provide techniques for determining that a rearward vehicle 202 is approaching or closely following a host vehicle 102 that is in the passing lane 210 of a highway 200. The rearward vehicle 202 is also referred to herein as a target vehicle and the vehicle 102 is also referred to as a host vehicle. “Closely following” herein means that a separation distance D between the host vehicle 102 and the rearward vehicle 202 is less than a distance that the rearward vehicle 202 will travel in a specified amount of time t₁. That the rearward vehicle 202 is “approaching” the host vehicle 102 herein means that the rearward vehicle 202 will reach the host vehicle 102 in less than a threshold amount of time tₜₕᵣₑₛₕ₁. In response to a determination that the rearward vehicle 202 is approaching or closely following the host vehicle 102, the computer 104 can actuate components and/or systems of the vehicle 102. In an example, the computer 104 can initiate a lane change to move the vehicle 102 out of the passing lane 210 including actuating an actuator 122 of the vehicle steering system 126, for example. The computer 104 can initiate a lane change only when the lane change is feasible, i.e., the lane markings and the traffic in the adjacent lane actually allows a lane change to be performed.

In an example, the computer 104 initially determines that the host vehicle 102 is traveling in the passing lane 210 of a highway 200. In an example, the computer 104 can use vehicle sensors 108, such as a GNSS sensor to determine that the vehicle 102 is on a highway 200 (e.g., a road having multiple lanes 210-212 traveling in a single direction). The computer 104 can use, e.g., front facing cameras to identify lane attributes (e.g., lane markings and road edges) compared against high-definition maps to determine that the vehicle 102 is in a passing lane 210 of the highway 200. For example, the camera system can detect lane lines 204 and 208, line types, line colors, and road edges 206 using known image processing techniques. A passing lane 210 is typically defined as the inner most lane of a multilane highway 200. For example, in North America where vehicles travel on the right side of the road the passing lane 210 is the left-most lane of a multilane highway. A passing lane 210 in North America thus typically has a solid yellow line 204 on the left and a dashed white line 208 on the right. In some examples, the disclosed techniques can be applied to any host vehicle not traveling in a right-most lane when a rearward vehicle is closely following or approaching.

Determining that the rearward target vehicle 202 is “closely following” includes determining that a separation distance D between the host vehicle 102 and the target vehicle 202 is less than a distance (V_{T}*t₁) that the target vehicle 202 will travel in a specified amount of time t₁, where V_{T} is the velocity of the target vehicle 202:

$$D < {V}_{T} * {t}_{1} {t}_{1} = 0.5 second .$$

The specified amount of time t₁ or “time headway” represents the time gap between the target vehicle 202 and the host vehicle 102. That is, time headway (or a “time gap”) herein means the elapsed time between the host vehicle 102 (e.g., determined by a rearmost portion of the host vehicle 102) passing a point on the roadway and the target vehicle 202 (e.g., determined by a rearmost portion of the target vehicle 202) passing the same point. For purposes of initiating a lane change, when the separation distance D between the target vehicle 202 and the host vehicle 102 is less than the target vehicle 202 velocity V_{T} multiplied by the specified time headway t₁, the computer 104 can determine that the target vehicle 202 is closely following and may attempt to pass the host vehicle 102.

As noted above, the specified amount of time t₁ can be specified based on rules and regulations specific to the location and operation of the vehicle (e.g., Federal, state, country, city, etc.). For example, some driver education programs in the United States recommend a time headway of at least 2 seconds. In some examples, the specified amount of time t₁ can be adjusted by the driver via the HMI 112. The specified amount of time t₁ can be increased by the driver, for example, to the driver's comfort with having a car closely following. Adjustments to the specified amount of time t₁ can be allowed within limits based on local rules and regulations, for example. Alternatively or additionally, the specified amount of time t₁ can be empirically determined, e.g., by operating test vehicles on a test track or the like and/or in simulations, and determining a time gap for a speed that appears to indicate that the target vehicle 202 is close to the host vehicle 102.

A host vehicle 102 can include sensors 108 that can be used to determine a separation distance D from other vehicles such as a target vehicle 202. For example, suitable techniques could use radar, cameras, or lidar sensors. Further for example, host vehicle 102 velocity can be measured using the vehicle wheel speed sensors.

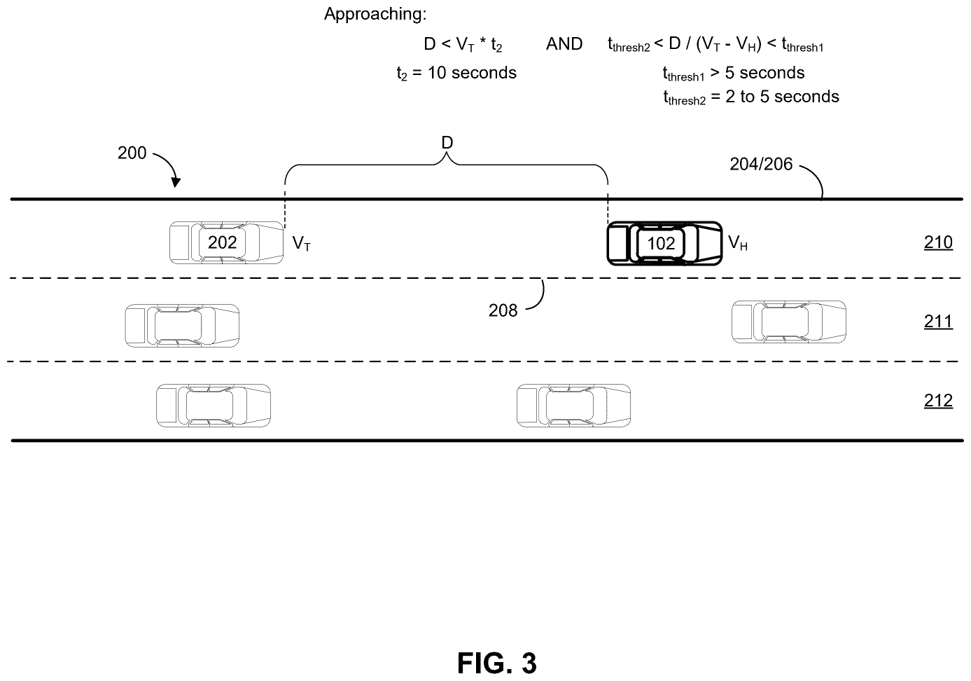

With reference to FIG. 3, determining that the rearward target vehicle 202 is “approaching” the host vehicle 102 includes determining that the target vehicle 202 will reach the host vehicle 102 in less than a threshold amount of time tₜₕᵣₑₛₕ₁. This threshold amount of time tₜₕᵣₑₛₕ₁ is the “time to arrival” which is the time to travel the distance between the host vehicle 102 and the target vehicle 202 at the relative velocity between the two vehicles 102, 202. Thus, the time to arrival can be determined by dividing the separation distance D by the difference in velocity (V_{T}−V_{H}), where V_{T} is the velocity of the target vehicle 202 and V_{H} is the velocity of the host vehicle 102. In an example, the threshold amount of time tₜₕᵣₑₛₕ₁ can be 5 seconds or greater. The system interprets a small time to arrival (e.g., less than 5 seconds) between the target vehicle 202 and the host vehicle 102 as an indication that the target vehicle 202 is approaching and wants to pass.

However, when the target vehicle 202 is quickly approaching, in such a way that the time to arrival at the host vehicle 102 is less than a low threshold tₜₕᵣₑₛₕ₂, e.g., 2 to 5 seconds, the system will not initiate a lane change to clear the passing lane 210. In such a situation the target vehicle 202 might be planning to change lanes to overtake the host vehicle 102 or might already have started changing lanes. With a very small time to arrival the computer 104 may maintain the host vehicle 102 in the passing lane 210 to prevent confusion or interfering with a lane change by the target vehicle 202.

Determining that the target vehicle 202 is approaching also includes determining that the separation distance D between the host vehicle 102 and the target vehicle 202 is less than a distance that the target vehicle 202 will travel in a specified amount of time t₂, e.g., 10 seconds. This time gap or “time headway” prevents reacting to the approaching target vehicle 202 when it may be perceived by the host vehicle 102 as being too early and/or too far away to move out of the passing lane.

Thus, the computer 104 may be programmed to initiate a host vehicle 102 lane change, when the target vehicle 202 is determined to be approaching, and moreover is approaching in a manner such that the target vehicle 202 will reach the host vehicle 102 in an amount of time between the threshold amount of time tₜₕᵣₑₛₕ₁ and the low threshold amount of time tₜₕᵣₑₛₕ₂ and the separation distance D is less than the distance (V_{T}*t₂) that the target vehicle 202 will travel in a specified amount of time t₂:

$${t}_{thresh 2} < D / ( {V}_{T} - {V}_{H} ) < {t}_{thresh 1} {t}_{thresh 1} > 5 seconds {t}_{thresh 2} = 2 to 5 seconds$$

$$AND$$

$$D < {V}_{T} * {t}_{2} {t}_{2} = 10 seconds$$

In some examples, the threshold amount of time tₜₕᵣₑₛₕ₁, low threshold tₜₕᵣₑₛₕ₂, and specified amount of time t₂ can be determined empirically by operating a test vehicle 102, either in the real world or virtually in a simulation, at various speeds and in various scenarios with a test target vehicle 202. Alternatively or additionally, time thresholds could be specified by a user, typically within parameters established by a vehicle manufacturer and/or applicable laws, rules, and/or regulations, via the HMI 112.

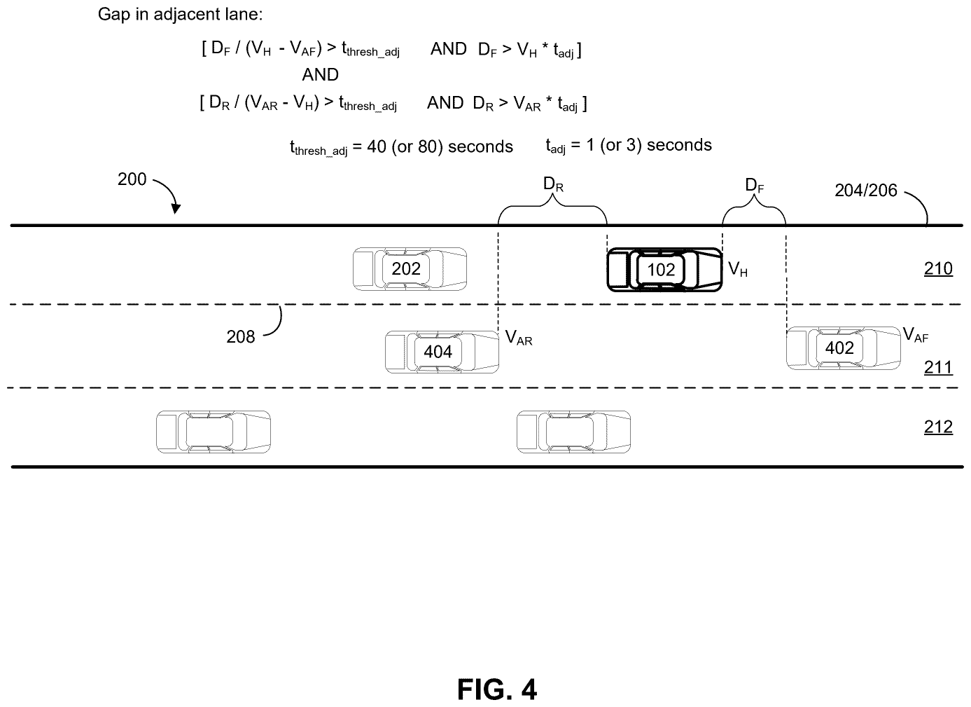

With reference to FIG. 4, before the computer 104 can initiate a lane change to move out of the passing lane 210 in response to an approaching or closely following target vehicle 202, the system determines whether a suitable gap exists in the adjacent lane 211 for a lane change of the host vehicle 102. In other words, the system determines whether a gap exists between a forward adjacent vehicle 402 and a rearward adjacent vehicle 404 in the lane 211 that is adjacent to the passing lane 210. A “suitable gap” means a distance between the forward and rearward adjacent vehicles 402, 404 such that the host vehicle 102 can move into the lane 211 occupied by the vehicles 402, 404 with the vehicle 402 forward of the host vehicle 102 and the vehicle 404 to the rear of the vehicle 102.

In an example, a suitable gap can be deemed to exist between the host vehicle 102 and the forward adjacent vehicle 402 when the time to arrival of the host vehicle 102 is greater than a specified time threshold t_{thresh_adj}, e.g., 40 seconds, and a separation distance DF between the host vehicle 102 and the forward adjacent vehicle 402 is greater than a distance that the host vehicle 102 will travel in a specified adjacent amount of time t_{adj}, e.g., 1 second.

A suitable gap can be deemed to exist between the host vehicle 102 and the rearward adjacent vehicle 404 when the time to arrival of the rearward adjacent vehicle 404 is greater than the threshold adjacent time t_{thresh_adj}, e.g., 40 seconds, and a separation distance DR between the host vehicle 102 and the rearward adjacent vehicle 404 is greater than a distance that the rear adjacent vehicle 404 will travel in the specified amount of time t_{adj}, for evaluating travel of the adjacent vehicle 404, e.g., 1 second.

$$[ {D}_{F} / ( {V}_{H} - {V}_{AF} ) > {t}_{thresh \_ adj} AND {D}_{F} > {V}_{H} * {t}_{adj} ]$$

$$AND$$

$$[ {D}_{R} / ( {V}_{AR} - {V}_{H} ) > {t}_{thresh \_ adj} AND {D}_{R} > {V}_{{AR}^{*}} {t}_{adj} ]$$

$${t}_{thresh \_ adj} = 40 ( or 80 ) {t}_{adj} = 1 ( or 3 )$$

In the case where there is not a closely following rearward vehicle 202 or when the approaching vehicle 202 is still far away, the threshold time t_{thresh_adj} and the specified amount of time t_{adj} can be increased to e.g., 80 seconds and 3 seconds, respectively. These larger amounts of time effectively increase the distances DF and DR between the host vehicle 102 and the adjacent vehicles 402 and 404. In the presence of a rearward vehicle 202, the system may accept getting closer to the adjacent vehicles 402 and 404 in the adjacent lane 211 than if there was not such a rearward vehicle 202, thus the lower amount of times for the threshold adjacent time t_{thresh_adj} and the specified adjacent amount of time t_{adj}. In some examples, the threshold time t_{thresh_adj} and the specified amount of time t_{adj} can be the same or different for the front and rear adjacent vehicles 402 and 404, respectively.

In some examples, the computer 104 can confirm the intention of a rearward vehicle 202 to pass the host vehicle 102 by detecting indicia provided by the rearward vehicle 202, e.g., detecting that a rearward vehicle is flashing its high-beams and/or if it has its turn indicator set to the left, even where both vehicles 102, 202 are already traveling in the leftmost passing lane 210. The high-beam and/or turn indicator of the target vehicle 202 can be detected using camera sensors 108, for example. In some examples, where the host vehicle 102 is driving in a lane with other vehicles in the passing lane 210 at a similar speed, the computer 104 can suppress initiation of a lane change such that the host vehicle 102 does not lose its position in a sequence of vehicles in a lane 210. In such a case the computer 104 could wait until a slower vehicle (e.g., forward adjacent vehicle 402) in the adjacent lane 211 has been passed by the host vehicle 102 to initiate the lane change.

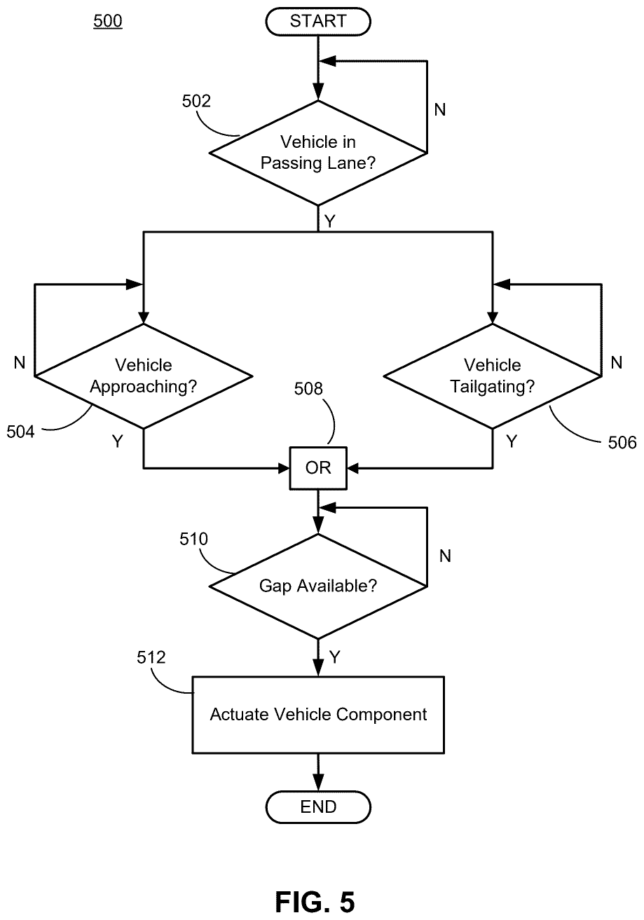

FIG. 5 is a process flow diagram illustrating an example process 500 for controlling host vehicle 102, including possibly to initiate a lane change, when a vehicle 102 is traveling in a passing lane 210 of a highway 200. Process 500 can be executed according to programming in a computer 104 included in the vehicle 102, for example. Process 500 includes multiple blocks that can be executed in the illustrated order. Process 500 could alternatively or additionally include fewer blocks or include the blocks executed in different orders.

Process 500 can begin at decision block 502, such as in response to vehicle 102 being placed into an ON state, or in a “drive” state to operate on a roadway, for example. Block 502 includes the computer 104 determining whether the vehicle 102 is in a passing lane 210 of a highway 200. In an example, the computer 104 can access high-definition maps and compare them to a GNSS location of the vehicle to determine that the vehicle 102 is on a highway. The computer 104 can use information from, e.g., front facing cameras 108 to identify lane attributes (e.g., lane markings and road edges) compared against high-definition maps to determine that the vehicle 102 is in a passing lane 210 of the highway 200. If the computer 104 determines that the vehicle 102 is in a passing lane 210, the process 500 continues to decision blocks 504 and 506, which can be executed in parallel, or one after the other, and/or implementations are possible that include only one of the blocks 504, 506, and not the other. If the vehicle 102 is not in a passing lane 210, then the process 500 returns to decision block 502 until the vehicle is determined to be in a passing lane 210.

At decision block 504, the computer 104 determines whether a rearward vehicle 202 in the passing lane 210 is approaching the vehicle 102. If the computer 104 determines that a rearward vehicle 202 is approaching the vehicle 102, the process continues to block 508. Otherwise, the process returns to decision block 504 to monitor traffic for an approaching vehicle.

At decision block 506, the computer 104 determines whether a rearward vehicle 202 in the passing lane 210 is closely following the vehicle 102. If the computer 104 determines that a rearward vehicle 202 is closely following the vehicle 102, the process continues to block 508. Otherwise, the process returns to decision block 506 to monitor traffic for a closely following vehicle.

At block 508, if either decision block 504 or decision block 506 has determined that a rearward vehicle 202 is approaching or closely following, respectively, the process continues at decision block 510.

At decision block 510, the computer 104 determines whether a suitable gap in traffic exists in an adjacent lane 211 to allow the vehicle 102 to change lanes and move out of the passing lane 210. If the computer 104 determines that a suitable gap exists, the process continues to block 512. Otherwise, the process returns to decision block 510 to monitor traffic for a suitable gap to accommodate a lane change.

At block 512, in response to a determination that a rearward vehicle 202 in the passing lane 210 is approaching or closely following the vehicle 102 and that a suitable gap in traffic exists, the computer 104 can actuate one or more components of the vehicle 102, such as operating a turn signal of the vehicle and actuating an actuator 122 of a steering system 126 of the vehicle 102. Alternatively or additionally, computer 104 can actuate one or more components of vehicle 102, such as steering, reducing propulsion of, and/or braking the vehicle 102 according to one or more predefined maneuvers to effect a lane change out of the passing lane 210. Any suitable technique for actuating a vehicle lane change could be utilized, for example. After block 512, process 500 ends.

Operations, systems, and methods described herein should always be implemented and/or performed in accordance with an applicable owner's/user's manual and/or safety guidelines.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

In the drawings, the same reference numbers indicate the same elements. Further, some or all of these elements could be changed. With regard to the media, processes, systems, methods, etc. described herein, it should be understood that, although the steps of such processes, etc. have been described as occurring according to a certain ordered sequence, unless indicated otherwise or clear from context, such processes could be practiced with the described steps performed in an order other than the order described herein. Likewise, it further should be understood that certain steps could be performed simultaneously, that other steps could be added, or that certain steps described herein could be omitted. In other words, the descriptions of processes herein are provided for the purpose of illustrating certain embodiments and should in no way be construed so as to limit the claimed invention.

The adjectives first and second are used throughout this document as identifiers and, unless explicitly stated otherwise, are not intended to signify importance, order, or quantity.

The term exemplary is used herein in the sense of signifying an example, e.g., a reference to an exemplary widget should be read as simply referring to an example of a widget.

Use of in response to, based on, and upon determining herein indicates a causal relationship, not merely a temporal relationship.

Computer executable instructions may be compiled or interpreted from computer programs created using a variety of programming languages and/or technologies, including, without limitation, and either alone or in combination, Java, C, C++, Visual Basic, Java Script, Perl, Python, HTML, etc. In general, a processor e.g., a microprocessor receives instructions, e.g., from a memory, a computer readable medium, etc., and executes these instructions, thereby performing one or more processes, including one or more of the processes described herein. Such instructions and other data may be stored and transmitted using a variety of computer readable media. A file in a networked device is generally a collection of data stored on a computer readable medium, such as a storage medium, a random-access memory, etc. A computer readable medium includes any medium that participates in providing data e.g., instructions, which may be read by a computer. Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

What is claimed is:

1. A system, comprising:
a computer that includes a processor and a memory, the memory including instructions executable by the processor to:
determine that a host vehicle is in a passing lane of a highway; and
in response to a determination that a rearward vehicle in the passing lane is approaching or closely following the host vehicle, actuate a component of the host vehicle.

2. The system of claim 1, wherein the instructions to determine that the rearward vehicle is closely following include instructions to determine that a separation distance between the host vehicle and the rearward vehicle is less than a distance that the rearward vehicle will travel in a specified amount of time.

3. The system of claim 1, wherein the instructions to determine that the rearward vehicle is approaching include instructions to determine that the rearward vehicle will reach the host vehicle in less than a threshold amount of time.

4. The system of claim 3, wherein the instructions to determine that the rearward vehicle is approaching include further instructions to determine that a separation distance between the host vehicle and the rearward vehicle is less than a distance that the rearward vehicle will travel in a specified amount of time.

5. The system of claim 3, wherein the instructions to determine that the rearward vehicle is approaching include instructions to determine that the rearward vehicle will reach the host vehicle in greater than a low threshold amount of time.

6. The system of claim 1, wherein the instructions include further instructions to determine that a gap exists between a forward adjacent vehicle and a rearward adjacent vehicle in a lane adjacent to the passing lane.

7. The system of claim 1, wherein the component is an actuator of a steering system of the host vehicle.

8. The system of claim 7, wherein the instructions include further instructions to actuate the actuator of the steering system to move the host vehicle out of the passing lane.

9. The system of claim 1, wherein the determination that the rearward vehicle is approaching or closely following is based on distance information received from a host vehicle sensor.

10. The system of claim 1, wherein the determination that the host vehicle is in the passing lane is based on lane attributes identified by a host vehicle camera.

11. A method, comprising:
determining that a host vehicle is in a passing lane of a highway; and
in response to a determination that a rearward vehicle in the passing lane is approaching or closely following the host vehicle, actuating a component of the host vehicle.

12. The method of claim 11, wherein determining that the rearward vehicle is closely following includes determining that a separation distance between the host vehicle and the rearward vehicle is less than a distance that the rearward vehicle will travel in a specified amount of time.

13. The method of claim 11, wherein determining that the rearward vehicle is approaching includes determining that the rearward vehicle will reach the host vehicle in less than a threshold amount of time.

14. The method of claim 13, wherein determining that the rearward vehicle is approaching includes determining that a separation distance between the host vehicle and the rearward vehicle is less than a distance that the rearward vehicle will travel in a specified amount of time.

15. The method of claim 13, wherein determining that the rearward vehicle is approaching includes determining that the rearward vehicle will reach the host vehicle in greater than a low threshold amount of time.

16. The method of claim 11, further comprising determining that a gap exists between a forward adjacent vehicle and a rearward adjacent vehicle in a lane adjacent to the passing lane.

17. The method of claim 11, wherein the component is an actuator of a steering system of the host vehicle.

18. The method of claim 17, further comprising actuating the actuator to move the host vehicle out of the passing lane.

19. The method of claim 11, wherein the determination that the rearward vehicle is approaching or closely following is based on distance information received from a host vehicle sensor.

20. The method of claim 11, wherein the determination that the host vehicle is in the passing lane is based on location information from a host vehicle GNSS sensor.
